(19) United States
(12) Patent Application Publication
(10) Pub. No.: US 2026/0309538 A1
(43) Pub. Date: Oct. 8, 2026

(54) WEIGHING SYSTEM HAVING AN ASTATIC LEVER

(71) Applicant: Sartorius Lab Instruments GmbH & Co. KG, Goettingen (DE)

(72) Inventors: Otto KUHLMANN, Bovenden (DE); Michael MUELLER, Goettingen (DE); Matthias GEISLER, Noerten-Hardenberg (DE); Alexander SCHUG, Bad Sachsa (DE)

(21) Appl. No.: 19/680,090

(22) Filed: May 18, 2026

Related U.S. Application Data
(63) Continuation of application No. PCT/EP2024/078562, filed on Oct. 10, 2024.

(30) Foreign Application Priority Data
Nov. 20, 2023 (DE) 10 2023 132 262.1

(51) Int. Cl. G01G 7/02; G01G 23/04; G01L 1/08

(52) U.S. Cl. CPC G01G 7/02; G01G 23/04; G01L 1/086

(57) ABSTRACT

A weighing system includes a base (12), a load receptor (14) articulated to the base with a parallel linkage arrangement, and a transmission lever (24) pivotably articulated to the base through a lever joint (25). The transmission lever has a first lever arm (241) connected to the load receptor via a load coupling band (28). A second transmission lever arm (242) carries at least one element of an electromagnetic compensatory sensor arrangement (26). An astatization force generating element fixed on one side to the base generates an astatization force introduced into an introduction point (32) of the transmission lever. An astatization lever (36) is pivotably connected to the base with an astatization lever joint (40), the astatization lever has first astatization lever arm (361) connected to the introduction point via an astatization coupling band (34) and a second astatization lever arm (362) operatively connected to the astatization force generating element.

### CROSS-REFERENCE TO RELATED APPLICATIONS

This is a Continuation of International Application PCT/EP2024/078562, which has an international filing date of Oct. 10, 2024, and the disclosure of which is incorporated in its entirety into the present Continuation by reference. This Continuation also claims foreign priority under 35 U.S.C. §119(a)-(d) to and also incorporates by reference, in its entirety, German Patent Application DE 10 2023 132 262.1 filed on Nov. 20, 2023.

### FIELD

The invention relates to a weighing system comprising
a base,
a load receptor articulated to the base with a parallel linkage arrangement,
a transmission lever pivotably articulated to the base through a transmission lever joint, the transmission lever having a first transmission lever arm connected to the load receptor via a load coupling band and the second transmission lever arm carrying at least one element of an electromagnetic compensatory sensor arrangement, and
an astatization force generating element fixed on one side to the base, which generates an astatization force to be introduced into an introduction point of the transmission lever.

### BACKGROUND

Gravimetric measuring devices, i.e., weighing devices, operating on the principle of electromagnetic compensation have long been known to those skilled in the art. For example, EP 2 690 415 A1 discloses such a weighing device.

The basic principle is that the deflection of a load receptor relative to a base caused by the weight of a load is transmitted via a transmission lever, realizing transmission of force and of displacement, to a sensor, which in turn is configured to exert an electromagnetic force on the lever arm in the opposite direction to the deflection. This compensating force depends on the current with which the coil of a moving-coil assembly generating the compensating force is energized. If the current is selected so that the load-induced deflection of the transmission lever is exactly compensated and the lever arm is therefore in its equilibrium position despite the applied load, the compensation current represents an exact measure of the required compensation force and therefore of the weight of the applied load.

Technically, such a system is usually implemented as follows: Via a parallel linkage arrangement, the so-called load receptor, to which a weighing pan is coupled, is articulated to a fixed base, whereby its degrees of freedom of movement are limited to a substantially vertical, tilt-free movement when the weighing device is correctly set up – at least for small deflections. The load receptor is connected to a transmission lever, in particular to its lever arm on the load receptor side, through of a so-called coupling band. The coupling band here is understood to be a predominantly elongated coupling that is flexible in predominantly only one bending direction. A thin sheet metal strip is often used for this purpose. It often has thin material sections near its end fixing points, so that the band, which is already predominantly only flexibly in one dimension due to its shape, is ultimately articulated at its fixing points. The transmission lever is mounted on a base-fixed lever joint, referred to here as the transmission lever joint, so that it can pivot. The bearing point represents the boundary between the load receptor side lever arm, referred to here as the first transmission lever arm, and the sensor side lever arm, referred to here as the second transmission lever arm. The coil of a moving coil arrangement is usually fixed at the end of the sensor side lever arm. It is immersed in the magnetic field of a base-fixed, usually pot-type magnet, typically a permanent magnet. Reverse arrangements with a base-fixed coil and lever-fixed (permanent) magnet are also feasible but uncommon. The position of the transmission lever in a specified reference load situation (usually unloaded in conventional scales, loaded in comparators) represents its equilibrium position. This equilibrium position can be detected with a separate position sensor, which usually works on an optical principle, or the lever can be adjusted so that in the reference load situation, it is in a position interpreted by the position sensor as the equilibrium position. When the coil is energized, a magnetic field corresponding to the coil current is generated, which interacts with the magnetic field of the permanent magnet, resulting in a force acting on the sensor side lever arm. Conversely, applying a load to the load receptor results in a mechanical force acting on the load receptor side lever arm. Using a suitable control system, such a device can be operated such that any (infinitesimal) load-induced deflection of the transmission lever is detected by the position sensor and converted into a compensatory change in the coil current. Thereby, the transmission lever remains in its equilibrium position (apart from infinitesimal deflections), such that the current flowing through the coil at the end of a settling process is representative of the load applied to the load receptor, the weight of which can be determined with high precision by measuring the coil current.

The mechanical part of this complex system is often referred to in technical jargon as a weighing system. These are highly precise, often monolithic devices which, despite the use of highly advanced precision technology, can still exhibit deviations from an ideal system. In particular, the so-called stiffness of the joints in such a weighing system represents one such deviation from the ideal system. Stiffness refers to the restoring force that a real joint (as opposed to an ideal joint) exerts against its deflection. As a rule, it is not possible to define the equilibrium position of the transmission lever as the position in which the transmission lever joint is exactly undeformed, i.e., in which no stiffness-induced torque is acting. Instead, a slightly different lever position is normally defined as the equilibrium position using the position sensor. Any coil current in the moving coil assembly that may be required to maintain this equilibrium position against a stiffness-induced torque is referred to below as offset current. In this context, we refer to "taring" the scale. However, there is a further deviation from the ideal system in the finite resolution with which the position sensor can detect the position of the transmission lever, in particular its equilibrium position. A deviation from the defined equilibrium position below this resolution limit therefore leads to a stiffness-related torque that is not compensated by the calibration and which is added – positively or negatively – to the torque caused by the weight of the load. The magnitude of this "error" torque depends on the actual joint stiffness, given a certain position deviation of the transmission lever. The aim of so-called astatization is to minimize the steepness of this essentially linear dependence so that the real deviations from the defined equilibrium position, which are unavoidable due to the finite position sensor resolution, result in as small an error torque as possible.

Various astatization approaches are known to those skilled in the art. One known astatization approach, for example, is to design the transmission lever so that its center of gravity is above the lever joint, i.e., above its exact pivot axis. This leads to destabilizing the equilibrium position of the transmission lever: due to the raised center of gravity, any deflection of the lever results in a torque that increases the deflection. This counteracts the reverse stiffness torque of the lever joint. Conversely, stabilization can be achieved by shifting the lever's center of gravity below its pivot axis. The disadvantage of this approach is that both the joint stiffness and the center of gravity of the transmission lever are subject to manufacturing deviations and therefore only compensate for each other exactly in rare exceptional cases. In addition, the system becomes more susceptible to tipping. The skilled person will recognize that relative orientation terms such as "above" or "over" and "below" or "under" are to be understood here in the context of proper alignment within the framework of a functional scale.

A similar result, but with less susceptibility to tipping, is achieved by a principle known from the aforementioned conventional EP 0 359 978 B1, in which the transmission lever carries a coupling point for one end of a tension spring above its lever joint, the other end of which is fixed to the base so that the tension spring is tensioned vertically across the transmission lever joint. This applies a force to the transmission lever that acts vertically from top to bottom and runs through the transmission lever joint. This force is introduced into the transmission lever via the spring coupling point, which acts as the introduction point for the astatization force. The mechanical implementation of this principle, which is still considered extremely favorable, is disclosed in EP 0 359 978 B1, but this publication is by now approximately 35 years old and is no longer compatible with modern, extremely high-resolution scales. In particular, it would be desirable to be able to reduce the force acting on the transmission lever joint in the equilibrium position in order to prevent material flow in the area of the joint, which is typically designed as an extremely delicate thin section. In addition, the direction of action of the spring force of the tension spring designed as a coil spring cannot be reproduced with sufficient precision to ensure that it always runs exactly through the pivot axis of the transmission lever, which would be necessary in high-resolution, modern scales.

### SUMMARY

It is an object of the present invention to provide a mechanical implementation of the astatization principle known from the conventional publication that is compatible with modern weighing systems.

According to one formulation this and other objects are achieved with an astatization lever pivotally connected to the base with an astatization lever joint, the first arm of which is connected to the introduction point via an astatization coupling band and the second arm of which is operatively connected to the astatization force generating element.

Exemplary embodiments are the subject of the dependent claims.

One idea underlying the invention is not to couple the astatization force generating element, which is preferably configured as a spring, in particular as a tension spring, directly to the introduction point, but instead indirectly via an additional mechanism consisting of an astatization lever and an astatization coupling band. By using the astatization coupling band, the direction of the astatization force acting on the introduction point can be defined much more precisely than if, for example, a tension spring configured as a coil spring were coupled there.

In addition, redirecting the astatization force with the astatization lever allows the entire force flow path to be extended and, in particular, its straight end section ending at the introduction point to be extended. The length of this end section of the force flow path is decisive – given a certain astatization force – for the strength of the astatization torque that is built up when the transmission lever is deflected from its equilibrium position. The greater the torque that can be achieved with a given force, the lower the force required to achieve the desired astatization torque. A reduction in the astatization force applied at the introduction point in turn results in a reduced load on the transmission lever joint in the equilibrium position of the transmission lever. This reduces the risk of material drift in the delicate transmission lever joint due to the continuous load exerted by the astatization force, which acts as a spring force, for example. With the same installation space and the same target astatization torque, the indirect introduction of the astatization force according to the invention allows a more delicate design of the weighing system, which benefits its sensitivity and therefore the resolution of the resulting scale.

As already indicated, in the case of the weighing system according to the invention, the astatization force generating element is also preferably configured as a spring, in particular as a tension spring. The first end of the spring is fixed to the base and its second end to the second astatization lever arm. This fixation may be an articulation. As a rule, however, the spring will be sufficiently flexible to compensate for the tiny deviations from a purely linear movement of the second astatization lever arm end that occur during the expected small deflections of the astatization lever. On the other, first astatization lever arm, compensation is provided by the properties of the coupling band, whose flexibility is precisely defined or restricted by its shape.

As is known from the prior art, the introduction point for the astatization force is preferably located above the transmission lever joint or the pivot axis defined by it. When a tensile force generated beyond the axis of rotation is used as the astatization force, this leads to a destabilizing effect. In other words, in such an embodiment, the material- and shape-related stiffness of the transmission lever joint is counteracted. If a stabilizing effect of the astatization is desired in individual cases, the introduction point can instead in corresponding embodiments be located below the transmission lever joint or the pivot axis defined by it.

Advantageously, the introduction point is axially co-located with the transmission lever joint or the pivot axis. The directional specification "axial" refers here to the longitudinal direction of the transmission lever. In this description, the abbreviated term "axially in relation to the ... lever" is also used for this and similar situations. When the transmission lever is aligned exactly horizontally in its equilibrium position, the introduction point is preferably located exactly vertically above the pivot axis. The point at which the lever side end of the astatization coupling band is fixed to the astatization lever should be located as precisely as possible in line with the connecting line between the introduction point and the transmission lever pivot axis, i.e., in the usual design, exactly vertically below the transmission lever pivot axis. However, especially when using a long coupling band, the accuracy of the position of this fixing point is less critical than the accuracy of the positioning of the introduction point relative to the transmission lever joint. However, if the transmission lever joint is capable of supporting (also) non-vertical forces, the line of action of the astatization force may also be oblique or even transverse to the vertical distance between the axis of rotation and the longitudinal extension of the lever. In any case, however, it should intersect the axis of rotation as precisely as possible.

Particularly in cases where the introduction point is located above the transmission lever joint, it is advantageous if the astatization coupling band is guided between two legs of the transmission lever, which has two laterally spaced legs at least in the area of the transmission lever joint. The functional transmission lever joint is then divided into two spaced-apart structural joints, preferably thin material sections, which together form the pivot axis for the transmission lever. Between these two structural joints or thin material sections, which each connect one of the parallel legs of the transmission lever to the base, there is sufficient space to allow the astatization coupling band to run through the transmission lever to the astatization lever.

Despite highly developed manufacturing techniques, especially in the precision milling of monolithic weighing systems, minor manufacturing tolerances may occur, which also affect the relative positioning of the introduction point and the transmission lever joint mentioned above. To compensate for this, a further development of the invention provides that the introduction point is configured to be axially adjustable in relation to the longitudinal direction of the transmission lever. In other words, in such an embodiment, the introduction point is arranged so that it can be displaced in the longitudinal direction of the transmission lever. This allows manufacturing tolerances to be compensated for in individual cases with appropriate adjustment, so that the direction of introduction of the astatization force runs exactly through the transmission lever joint or the pivot axis of the transmission lever.

Such an adjustment mechanism, which should be capable of compensating for deviations in the micrometer or even submicrometer range, is not trivial. One of several mechanical possibilities is that the introduction point is arranged on a sliding block that can be moved axially on the transmission lever in relation to the longitudinal direction of the transmission lever, and that the sliding block is indirectly forced against a stop fixedly connected to the transmission lever by a wedge that can be adjusted transversely to the longitudinal direction of the transmission lever. A displacement of the wedge transversely to the axial direction of the transmission lever thus leads to a change in the distance between the edge of the sliding block abutting the wedge and the stop fixed to the lever. When the wedge is retracted, the axial force acting on the sliding block pushes it towards the stop. When the wedge is pushed forward, however, the distance increases in the opposite direction to the force acting on the sliding block. The wedge can be moved, for example, with an adjustment screw with a fine thread. The force applied to the sliding block can be exerted by a spring, for example. However, the inherent elasticity of the material, usually an aluminum alloy, is often sufficient to accommodate the tiny displacements of the sliding block required for adjustment.

Alternatively or additionally, it may be provided that the entire astatization lever relative to the base, or at least the fixing point at which the astatization coupling band is fixed to the first astatization lever arm, is configured to be movable relative to the astatization lever, namely axially movable in relation to the astatization lever. Such displacement can also influence the inclination of the astatization coupling band and, in particular, adjust it so that it, or rather the line of action of the astatization force transmitted thereby, runs exactly through the axis of rotation of the transmission lever. The displacement of the entire astatization lever can be achieved in particular by displacing its astatization lever joint using a suitable displacement mechanism mounted on the base. The isolated displacement of the astatization coupling band fixing point can be carried out with a suitable displacement mechanism mounted on the astatization lever. Compared to the previously described variant of a displacement of the introduction point relative to the transmission lever, such embodiments even have the advantage that the adjustment is less sensitive and therefore fundamentally easier to implement mechanically. The reason for this is the typically greater distance between the axis of rotation of the transmission lever on the one hand and the introduction point or the fixing point of the astatization coupling band on the astatization lever on the other. In practice, however, the installation space in the area of the astatization lever is limited and/or difficult to access, so that an adjustment option located here encounters handling difficulties.

It is advantageous if the strength of the astatization force is also adjustable. In the preferred case of the configuration of the astatization force generating element as a spring, in particular a tension spring, this can be achieved by making the fixing position of the spring at the base adjustable in the direction of force action of the spring. In other words, the preload of the spring is varied. This allows, in particular, manufacturing tolerances of the spring as well as of the joints themselves to be compensated.

Further details and advantages of the invention are apparent from the following specific description and the drawings.

### BRIEF DESCRIPTION OF THE DRAWINGS

They show:

FIG. 1: a highly simplified representation of a weighing system according to the invention,

FIG. 2: an enlarged representation of the transmission lever joint of the weighing system from FIG. 1 in a schematic side view and

FIG. 3: an enlarged representation of the transmission lever joint of the weighing system of FIG. 1 in a schematic front view.

### DETAILED DESCRIPTION

Identical reference symbols in the figures indicate identical or analogous elements.

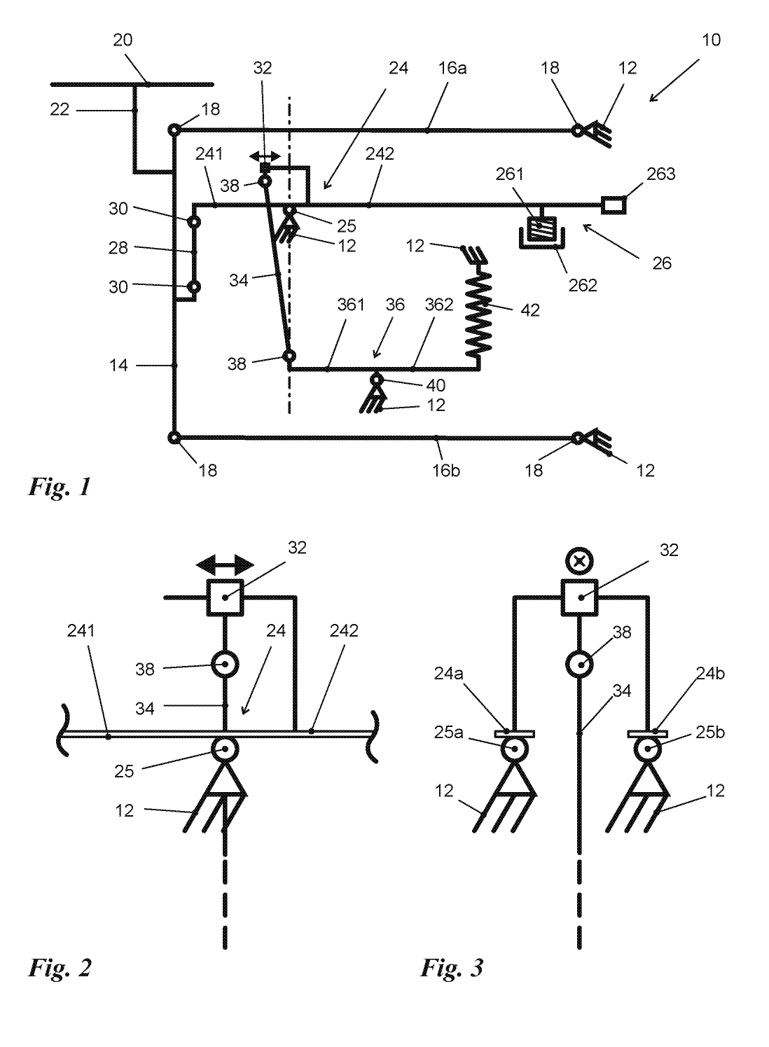

FIG. 1 shows a highly schematic side view of a weighing system 10 according to the invention. The base 12 of the weighing system 10, often referred to in technical jargon as the "mainland" or "system carrier", is only vaguely indicated in the figures. The weighing system 10 has a Roberval mechanism with which a load receptor 14 is articulated to the base 12 via two parallel links 16a, 16b. Both parallel links 16a, 16b are articulated on the one hand to the base 12 and on the other hand to the load receptor 14 through joints, referred to here as Roberval joints 18, which are preferably configured as thin material sections. The load receptor 14 is connected to a weighing goods carrier 20, wherein this connection is made via a cantilever arm 22 in the embodiment shown.

Furthermore, the weighing system 10 has a transmission lever 24, which is constructed from a receptor side, first transmission load lever arm 241 and a second transmission lever arm 242. The boundary between the first and second transmission lever arms 241, 242 is located axially at the level of a transmission lever joint 25, which is preferably configured as a thin material section and with which the transmission lever 24 is pivotably connected to the base 12. At its free end, the second transmission lever arm 242 carries components of a sensor arrangement 26. In the case shown, this is, on the one hand, the moving coil 261 of an electromagnetic compensatory sensor that also comprises a pot magnet 262 fixed to the base. On the other hand, the second transmission lever arm 242 carries the target 263 of an optical position sensor, which is not shown in greater detail here.

The free end of the first transmission lever arm 241 is connected to the load receptor 14 via a load coupling band 28. In particular, the load coupling band 28 can consist of a sheet metal strip which has a coupling band joint 30 configured as a thin material section near each of its two ends.

In this respect, the weighing system according to the invention does not differ from known weighing systems for electromagnetically compensating scales (EMC scales) and also corresponds to these in terms of its basic functionality. A load placed on the weighing goods 20 exerts a weight force on the load receptor 14, which tends to deflect vertically downward in response to this force. The force or the resulting tendency to deflect is transmitted via the load coupling band 28 to the transmission lever 24, whose first transmission lever arm 241 tends to be pulled downwards and whose second transmission lever arm 242 tends to be pushed upwards. The deflection is detected by the optical position detector and the coil 261 of the sensor 26 is supplied with just enough current to completely suppress this deflection and, after a settling process, to hold the transmission lever 24 in its equilibrium position. The compensation current required for this through the coil 261 is representative of the weight force exerted by the weighed material.

A special feature of the present invention relates to the specific manner in which a positioning force is introduced into the transmission lever 24. For better clarity, the corresponding mechanism is shown in FIG. 1 in a significantly misaligned state. In FIGS. 2 and 3, however, it is shown in section with the correct alignment. Above the transmission lever joint 25 there is an introduction point 32 that can be displaced in the longitudinal or axial direction of the transmission lever 24. Purely schematically, it is shown in the figures on the upper leg of a cantilever arm. In practice, however, it will normally be located directly on the upper side of the transmission lever 24 itself. During operation, as shown in FIGS. 2 and 3, the introduction point 32 should be located exactly above the pivot axis formed by the transmission lever joint 25, or at least be adjustable to such a position. This optimal adjustment is also referred to here as the axial co-localization of the introduction point and the pivot axis. The introduction point 32 is connected via an alignment coupling band 34 to the first lever arm of an alignment lever 36, referred to here as the first alignment lever arm 361. Similar to the load coupling band 28, the astatization coupling band 34 is preferably configured as a sheet metal strip which carries a coupling band joint 38 configured as a thin material section at each of its ends. In the embodiment shown, the astatization lever 36 is arranged below the transmission lever 24 and is pivotably connected to the base 12 via an astatization lever joint 40, which is preferably configured as a thin material section. In particular, it is positioned so that the coupling point of its first astatization lever arm 361 with the astatization coupling band 34 lies substantially exactly below the pivot axis of the transmission lever 24 formed by the transmission lever joint 25. However, this is not absolutely necessary, at least in cases where the transmission lever joint 25 is also capable of supporting non-vertical forces. The second lever arm of the astatization lever 36, referred to here as the second astatization lever arm 362, is preloaded against the base 12 via a spring 42, which is configured here as a tension spring. In the embodiment shown, the tension spring 42 exerts an upward force on the second astatization lever arm 362.

When correctly adjusted, as shown in FIGS. 2 and 3, this force is redirected with the astatization lever 36 and introduced into the introduction point 32 so that the force acting on the transmission lever 24 in the equilibrium position of the transmission lever 24 runs exactly through the pivot axis defined by the transmission lever joint 25. It is therefore completely supported by the transmission lever joint 25. This results in no torque acting on the transmission lever 24. If, on the other hand, the transmission lever 24 is deflected from its equilibrium position, in particular by the weight of a load placed on the weighing goods carrier 20, the force flow line shifts and runs axially next to the pivot axis. The transmission lever joint 25 then no longer fully supports the introduced astatization force, resulting in an astatization torque that amplifies the deflection of the transmission lever 24 caused by the weight force, which counteracts an opposing torque caused by stiffness.

The indirect introduction of the astatization force generated by the spring 42 via the astatization lever 36 and the astatization coupling band 34 has the advantage that the direction of action of the introduced astatization force is precisely defined in the area of the transmission lever joint 25 – unlike if the spring 42 were coupled directly to the introduction point 32. As a result, the astatization effect is highly reproducible and, in embodiments such as the one shown, can even be precisely adjusted.

FIG. 3 shows a front view of the section of the weighing system 10 shown in FIG. 2 in side view. In this exemplary embodiment, the transmission lever 24 is configured in the form of two parallel legs 24a, 24b, at least in the area of the transmission lever joint 25. In this embodiment, the transmission lever joint 25 is configured as two spaced-apart thin material sections 25a, 25b, which together define the pivot axis of the transmission lever 24. In this embodiment, the astatization coupling band 34 can run between the two legs 24a, 24b of the transmission lever 24 or the two thin material sections 25a, 25b of the transmission lever joint 25.

The embodiments discussed in the specific description and shown in the figures are illustrative examples of the present invention. In light of the disclosure herein, a wide range of feasible variations is available to those skilled in the art. For instance, variants are feasible in which the spring 42 is configured as a compression spring instead of a tension spring and/or acts in the opposite direction on the second astatization lever arm 362. It is also feasible to arrange the introduction point 32 below instead of above the pivot axis of the transmission lever 24. This allows the skilled person to generate the desired positive or negative astatization in each individual case. With regard to the specific mechanics of any axial adjustability of the introduction point 32, the skilled person has at his or her disposal all known and, if necessary, yet to be developed precision mechanical implementations.

### LIST OF REFERENCE MARKS

10 Weighing system

12 Base

14 Load receptor

16a Upper parallel link

16b Lower parallel link

18 Roberval joint

20 Weighing pan

22 Cantilever arm

24 Transmission lever

24a Leg of 24

24b Leg of 24

241 First transmission lever arm

242 Second transmission lever arm

25 Transmission lever joint

25a Thin material section of 25

25b Thin material section of 25

26 Sensor arrangement

261 Moving coil

262 Pot magnet

263 Target

28 Load coupling band

30 Coupling band joint

32 Introduction point

34 Astatization coupling band for

36 Astatization lever

361 First astatization lever arm

362 Second astatization lever arm

38 Coupling band joint

40 Astatization lever joint

42 Spring

What is claimed is:

1. A weighing system comprising:
a base,
a load receptor articulated to the base with a parallel linkage arrangement,
a transmission lever pivotably articulated to the base via a transmission lever joint, the transmission lever having a first transmission lever arm connected to the load receptor via a load coupling band and a second transmission lever arm carrying at least one element of an electromagnetic compensatory sensor arrangement, and
an astatization force generating element fixed on one side to the base, and configured to generate an astatization force introduced into an introduction point of the transmission lever,
wherein an astatization lever pivotably connected to the base via an astatization lever joint, the astatization lever having a first astatization lever arm connected to the introduction point via an astatization coupling band and a second astatization lever arm operatively connected to the astatization force generating element.

2. The weighing system according to claim 1,
wherein the astatization force generating element is configured as a spring, a first end of which is fixed to the base and a second end of which is fixed to the second astatization lever arm.

3. The weighing system according to claim 2,
wherein the spring is configured as a tension spring.

4. The weighing system according to claim 1,
wherein the introduction point is arranged above the transmission lever joint.

5. The weighing system according to claim 1,
wherein the introduction point is – in relation to the transmission lever – axially co-located with a pivot axis of the transmission lever defined by the transmission lever joint.

6. The weighing system according to claim 1,
wherein the transmission lever has two legs spaced apart laterally from each other at least in the area of the transmission lever joint, and the astatization coupling band runs between the two legs.

7. The weighing system according to claim 1,
wherein the introduction point is configured – in relation to the transmission lever – to adjust axially in relation to the transmission lever.

8. The weighing system according to claim 7,
wherein the introduction point is arranged on a sliding block which is – in relation to the transmission lever – axially displaceable on the transmission lever and which is indirectly acted upon by a force via a wedge adjustable transversely to the axial direction of the transmission lever against a stop fixedly connected to the transmission lever.

9. The weighing system according to claim 1,
wherein the fixing point at which the astatization coupling band is fixed to the first astatization lever arm is configured – with respect to the astatization lever – to move axially relative to the astatization lever.

10. The weighing system according to claim 1,
wherein the astatization lever joint together with the astatization lever is configured – with respect to the astatization lever – to adjust axially relative to the base.

11. The weighing system according to claim 1,
wherein a strength of the astatization force is adjustable.

12. The weighing system according to claim 11,
wherein the astatization force generating element is configured as a spring, a first end of which is fixed to the base and a second end of which is fixed to the second astatization lever arm, and wherein a fixing position of the spring on the base is adjustable in a force action direction of the spring.
